(19) United States
(12) Patent Application Publication
(10) Pub. No.: US 2021/0243440 A1
(43) Pub. Date: Aug. 5, 2021

(54) IMAGE PROCESSING APPARATUS AND IMAGE PROCESSING METHOD

(71) Applicant: SONY CORPORATION, TOKYO (JP)

(72) Inventor: YU NAKADA, KANAGAWA (JP)

(21) Appl. No.: 17/250,160

(22) PCT Filed: Jun. 3, 2019
(86) PCT No.: PCT/JP2019/021903

§ 371 Date: Dec. 7, 2020

(30) Foreign Application Priority Data
Jun. 14, 2018 (JP) 2018-113350

(51) Int. Cl. H04N 19/119; H04N 19/157; H04N 19/174

(52) U.S. Cl. CPC H04N 19/119; H04N 19/174; H04N 19/157

(57) ABSTRACT

The present technology relates to an image processing apparatus and an image processing method for reducing the processing time required for decoding. A search section divides an access unit constituted by multiple process regions into multiple search regions having sizes different from those of the process regions. The search section further performs a search for a start position of the process region serving as a reference by which to allocate the process regions to multiple decoding sections individually. The search section further starts the search in a likely candidate region formed by the search region highly likely to include the process region start position. The present technology can be applied to an image processing system.

### TECHNICAL FIELD

The present technology relates to an image processing apparatus and an image processing method. More particularly, the technology relates to an image processing apparatus and an image processing method for reducing the processing time required for decoding.

### BACKGROUND ART

When a system that has multiple decoding sections decodes an AU (access unit) including multiple slices, the slices are allocated to the multiple decoding sections to distribute the load of the processing. In the case where the slices are allocated to the multiple decoding sections, it is necessary to find out the start position of each of the slices.

An ordinary search for the start position of each slice involves searching the entire AU successively from the beginning to detect a StartCode for finding out a NAL UNIT. If the detected NAL UNIT is a slice NAL, an offset value indicating the start position of the slice is stored, before the search is resumed for the next StartCode in an unsearched region. The slice NAL is a NAL UNIT for use in slice transmission. This process is repeated until the end of the AU is reached. In such a manner, the offset values indicating the start positions of all slices are acquired. This makes it possible to determine how the slices are to be allocated to the multiple decoding sections.

However, obtaining the offset values indicative of the start positions of all slices requires searching the entire AU from beginning to end for the StartCodes therein. This can take an enormous amount of time.

In view of this, PTL 1 proposes that when the AU is encoded as a stream, the StartCodes serving as the points of search be suitably arranged to appear periodically so as to improve the ease of the search.

### CITATION LIST

### Patent Literature

[PTL 1]

Japanese Patent Laid-open No. 2000-236238

### SUMMARY

### Technical Problems

However, according to the proposal of PTL 1, normally unwanted data needs to be added to make the StartCodes appear periodically. This can increase the size of the stream. Furthermore, the proposed arrangements are to be made when streams are encoded, and it is difficult to use the arrangements in conjunction with already exiting streams.

The present technology has been devised in view of the above circumstances and is aimed at reducing the processing time required for decoding.

### Solution to Problems

According to one aspect of the present technology, there is provided an image processing apparatus including a search section configured to divide an access unit constituted by multiple process regions into multiple search regions having sizes different from those of the process regions, the search section being further configured to perform a search for a start position of the process region serving as a reference by which to allocate the process regions to multiple decoding sections individually, the search section being further configured to start the search in a likely candidate region formed by the search region highly likely to include the process region start position.

According to one aspect of the present technology, an access unit constituted by multiple process regions is divided into multiple search regions having sizes different from those of the process regions. A search is made for a start position of the process region serving as a reference by which to allocate the process regions to multiple decoding sections individually. The search is started in a likely candidate region formed by the search region highly likely to include the process region start position.

### Advantageous Effects of Invention

According to the present technology, it is possible to reduce the processing time required for decoding.

The advantageous effects outlined above are not necessarily limitative, and may be any of the effects described in the present disclosure.

### BRIEF DESCRIPTION OF DRAWINGS

FIG. 1 is a view depicting typical effects of an increase in image resolution on the processing time for decoding.

FIG. 2 is a view depicting an example of how an AU is divided.

FIG. 3 is a view depicting a typical process of allocating slices.

FIG. 4 is a view depicting a configuration example of an image processing system related to one embodiment of the present technology.

FIG. 5 is a view depicting a configuration example of a stream.

FIG. 6 is a block diagram depicting a simplified configuration example of a decoding apparatus.

FIG. 7 is a view depicting a first example of the process of searching for a slice start position.

FIG. 8 is a view depicting a second example of the process of searching for a slice start position.

FIG. 9 is a view depicting a third example of the process of searching for a slice start position.

FIG. 10 is a view depicting typical search regions in a case where the AU is divided by size into three regions.

FIG. 11 is a view depicting another typical order of search.

FIG. 12 is a block diagram depicting another simplified configuration example of the decoding apparatus.

FIG. 13 is a view depicting an example of search performed by the decoding apparatus 11 in FIG. 12 in a case where the predicted number of assumed regions is three and the number of decoding sections is three.

FIG. 14 is a block diagram depicting another simplified configuration example of the decoding apparatus.

FIG. 15 is a view depicting an example in which the decoding apparatus 11 in FIG. 14 allocates eight slices to four decoding sections.

FIG. 16 is a block diagram depicting a detailed configuration example of the decoding apparatus.

FIG. 17 is a flowchart explaining the process performed by the decoding apparatus in FIG. 16.

FIG. 18 is a flowchart explaining the process of searching for a slice start position in step S103 in FIG. 17.

FIG. 19 is a flowchart explaining the process of decoding the slices in step S104 in FIG. 17.

FIG. 20 is a flowchart explaining an ordinary process of searching for slices.

FIG. 21 is a block diagram depicting a hardware configuration example of a computer.

### DESCRIPTION OF EMBODIMENTS

Some embodiments for implementing the present technology are described below. The description will be given under the following headings.
1. Methods of searching for slices
2. Details of the decoding apparatus
3. Computer

<1. Methods of Searching for Slices>

<Ordinary Search Method>

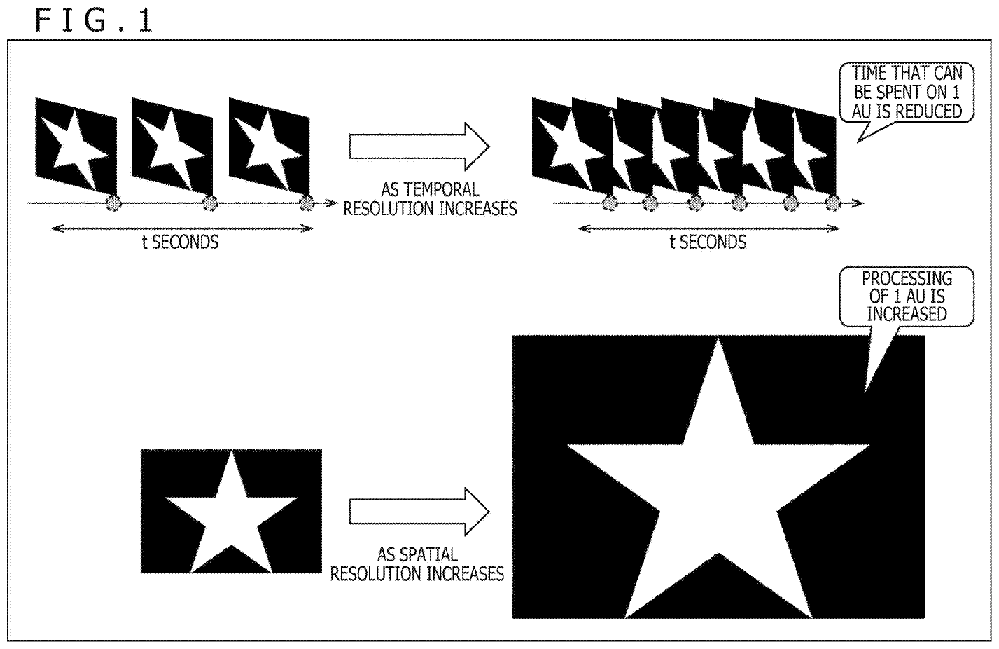

FIG. 1 is a view depicting typical effects of an increase in image resolution on the processing time for decoding.

The methods of MPEG, AVC, and HEVC are extensively used for compressing moving images. The resolution of moving images conceptually involves two types of resolutions: temporal resolution in the time direction, and spatial resolution in the space direction. In recent years, these two types of resolutions have steadily been increased.

The temporal resolution is represented by framerate. Recent years have seen systems developed to support the temporal resolution at high framerates of 120 fps or more. In a case where the temporal resolution is increased, the decoding section has less time to spend on a single AU (access unit). One AU corresponds to one screen (frame) of a moving image.

The upper part in FIG. 1 gives an example in which an increase in temporal resolution requires that only t/7 seconds be spent on decoding one AU instead of t/3 seconds.

Meanwhile, the spatial resolution is represented by image size. Recent years have seen systems developed to support the image size of 8K or more in addition to 4K in terms of spatial resolution. In a case where the spatial resolution is increased, there are more targets to be decoded, requiring the decoding section to handle a larger amount of processing. This leads an increase in the processing time required for each AU.

The lower part in FIG. 1 gives an example in which the image size is doubled horizontally and vertically.

The increases in these resolutions keep shortening the time that can be spent on decoding one AU. Methods of efficiently decoding moving images are thus needed. One such method may conceivably involve boosting the performance of HW (hardware) of the decoding section. Another method may involve parallelly using multiple decoding sections each offering mediocre performance.

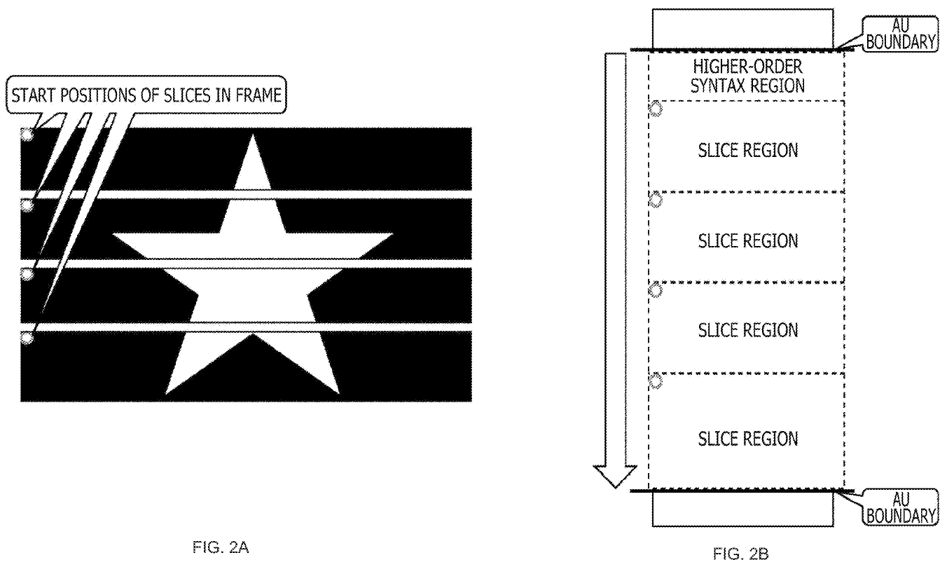

FIG. 2 is a view depicting an example of how an AU is divided.

As illustrated in A of FIG. 2, one AU is configured with multiple slices. In this example, four slices constitute one AU. The top left corner of each slice has a circle indicating the start position of the slice.

B in FIG. 2 depicts an illustrative image of a memory that stores AU data.

As illustrated in B of FIG. 2, the memory has a higher-order syntax region and slice regions formed in that order, the higher-order syntax region storing a higher-order syntax constituting part of the AU, the slice regions storing four slices depicted in A of FIG. 2. In the top left corner of each slice region is a circle indicative of the start position of the slice. In practice, it is to be noted that the start position of each slice is not necessarily arranged at the left end of the memory area.

A downward arrow in B of FIG. 2 indicates that an entire AU in the memory is searched from top to bottom, i.e., from the start position to the end position, for a slice start position on the decoding side.

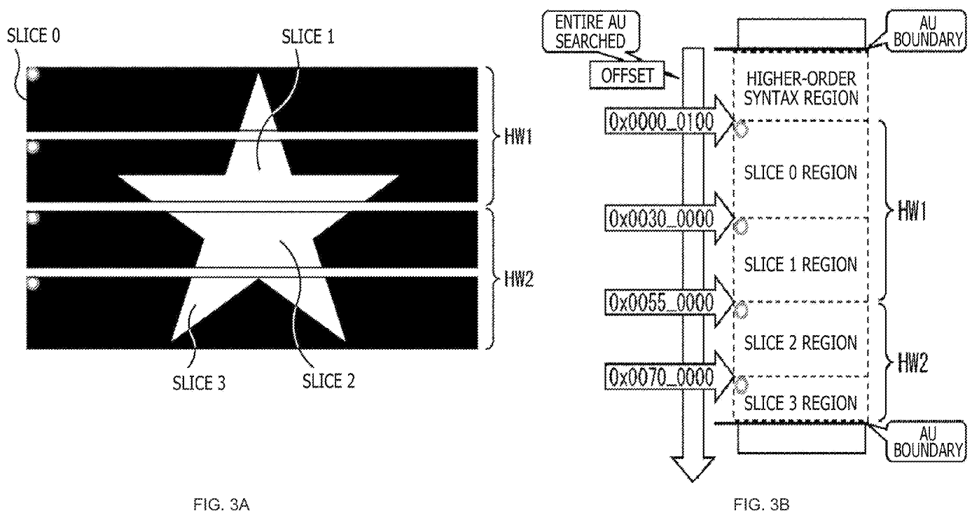

FIG. 3 is a view depicting a typical process of allocating slices. The explanations already given with respect to FIG. 2 are omitted below where appropriate.

As depicted in A of FIG. 3, in a case where one AU is configured with four slices, i.e., slice 0, slice 1, slice 2, and slice 3, the memory has a slice 0 region, a slice 1 region, a slice 2 region, and a slice 3 region formed therein to accumulate the corresponding slice data as illustrated in B of FIG. 3.

The start position of slice 0 is indicated by a circle in the top left corner of the slice 0 region. In the example in B of FIG. 3, the offset value for the start position of slice 0 is 0x0000_0100. Likewise, the offset values for the start positions of slices 1 through 3 are 0x030_0000, 0 x0055_0000, and 0x0070_0000, respectively.

In a case where the offset value for each slice in the AU is to be obtained, a search is made for a StartCode in order to detect a NAL UNIT. It is then determined whether or not the detected NAL UNIT is a slice NAL. In a case where the NAL UNIT is determined to be a slice NAL, the start position of that NAL UNIT is identified as the slice start position, and its offset value is retained.

In the example in B of FIG. 3, information is retained first regarding the offset value of 0x0000_0100 indicting the start position of slice 0 detected by a search targeted for the slice 0 region. With similar processing repeated, the offset value of 0x0030_0000 indicating the start position of slice 1, the offset value of 0x0055_0000 indicating the start position of slice 2, and the offset value of 0x0070_0000 indicating the start position of slice 3 are retained, in that order.

On the basis of the reset values above, four slices are allocated to two decoding sections HW1 and HW2. In the example of FIG. 3, slice 0 accumulated in the slice 0 region and slice 1 accumulated in the slice 1 region are allocated to the decoding section HW1, and slice 2 accumulated in the slice 2 region and slice 3 accumulated in the slice 3 region are allocated to the decoding section HW2. The decoding section HW1 decodes the slices starting from the offset value of 0x0000_0100, and the decoding section HW2 decodes the slices starting from the offset value of 0x0055_0000.

As described above, obtaining each offset value requires searching for a StartCode from the beginning of the target AU. This takes an enormous amount of time.

<Configuration Example of the Image System>

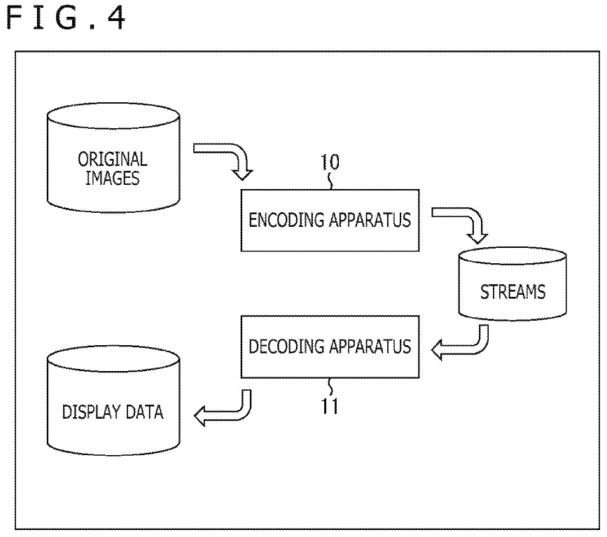

FIG. 4 is a view depicting a configuration example of an image processing system related to one embodiment of the present technology.

In the example of FIG. 4, an image processing system 1 is configured with an encoding apparatus 10 and a decoding apparatus 11.

The encoding apparatus 10 generates a stream by encoding the original image. The stream is configured with multiple AUs. For example, the image processing system 1 uses, as its encoding method, MPEG (Moving Picture Experts Group), H.264 and MPEG-4 Part 10 (Advanced Video Coding, abbreviated to AVC hereunder), or HEVC (High Efficiency Video Coding).

The decoding apparatus 11 acquires the stream generated by the encoding apparatus 10. The decoding apparatus 11 includes multiple decoding sections configured with HW each.

The decoding apparatus 11 allocates the slices of the AUs constituting the stream to the multiple decoding sections so that the decoding sections will decode the slices in parallel. The decoding apparatus 11 generates display data using the results of the decoding performed by the decoding sections.

<Configuration Example of the Stream>

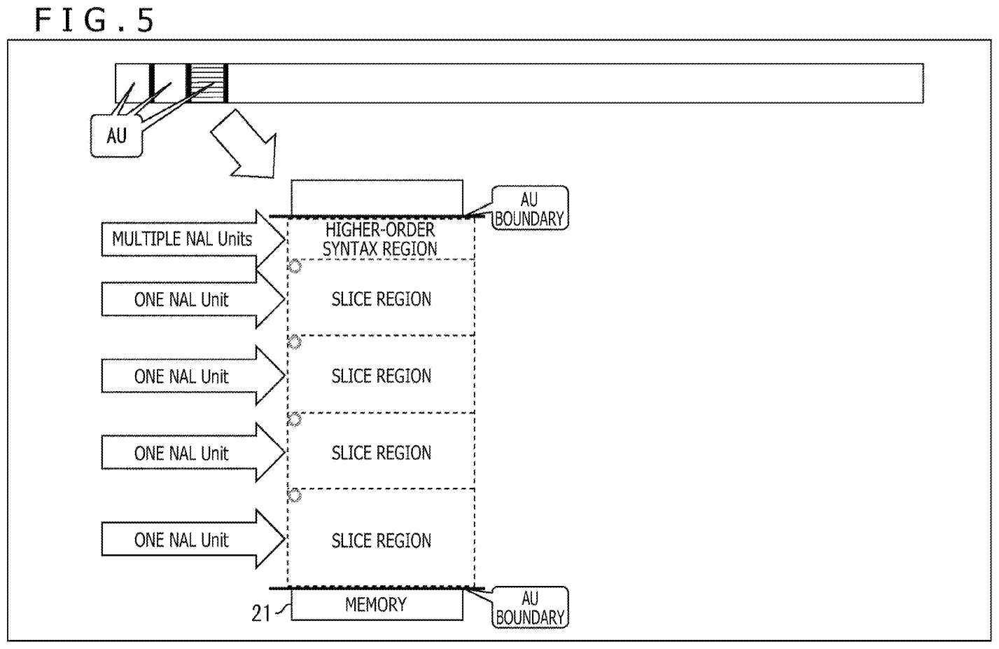

FIG. 5 is a view depicting a configuration example of a stream.

As depicted in FIG. 5, the stream targeted for decoding by the decoding apparatus 11 is configured with multiple AUs. The data of the stream is accumulated in a memory 21 in units of the AUs making up the stream.

As pointed to by a hollow arrow, one AU is configured with a higher-order syntax and multiple slices. The higher-order syntax is transmitted by use of multiple NAL UNITs. Each of the slices is transmitted by use of a single NAL UNIT. In the example in FIG. 5, four slices are included in the AU.

In this case, a higher-order syntax region as the region for the higher-order syntax and slice regions as the regions for the four slices are formed in the memory 21. In the higher-order syntax, AUD, VPS, SPS, PPS, and SEI are described, for example. It is to be noted that all syntaxes are not necessarily present.

<Example of Search Performed by the Decoding Apparatus Having Two Decoding Sections>

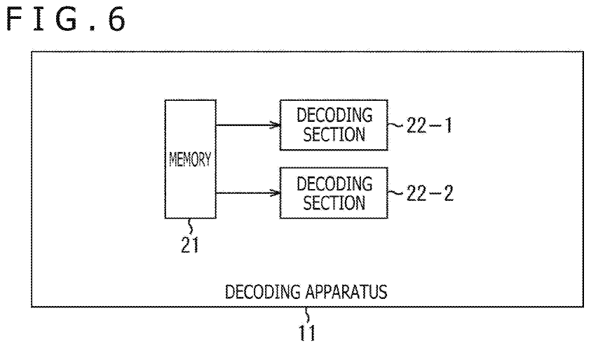

FIG. 6 is a block diagram depicting a simplified configuration example of the decoding apparatus.

As depicted in FIG. 6, the decoding apparatus 11 is configured with a memory 21 that accumulates the stream and two decoding sections 22-1 and 22-2. In a case where there is no need to distinguish the decoding sections 22-1 and 22-2 from each other, they are collectively referred to as the decoding sections 22.

The decoding apparatus 11 divides each AU accumulated in the memory 21 to multiple (n) search regions evenly in units of a predetermined number of bytes. The search regions make up a search range in which a search is made for a slice start position. The sizes of the search regions differ from those of the slices.

The decoding apparatus 11 starts a search for a slice start position in one of the multiple search regions that constitutes a likely candidate region highly likely to include the slice start position as an allocation point.

Here, the data constituting each AU is allocated in units of slices to the decoding sections 22 in such a manner that approximately the same amount of data is allocated to each decoding section 22. The allocation point is the slice start position in reference to which the data is allocated to the decoding sections 22.

In a case where the decoding apparatus 11 detects the allocation point by searching the likely candidate region, the decoding apparatus 11 terminates the search at that point in time. The decoding apparatus 11 then allocates the AU data to the decoding sections 22-1 and 22-2 individually in reference to the allocation point to let the decoding sections decode the allocated data. For example, the data preceding the allocation point is allocated to the decoding section 22-1, and the data subsequent to the allocation point is allocated to the decoding section 22-2.

In such a manner, the decoding apparatus 11 arranges to set the regions constituting the search range and to determine the order of search therein, before decoding the AU. By starting the search in the likely candidate region, it is possible to improve the efficiency of search through elimination of search attempts that are deemed wasteful. Improving the efficiency of search for the slice start position makes it possible to shorten the processing time for all AUs.

<First Example of Searching for the Slice Start Position>

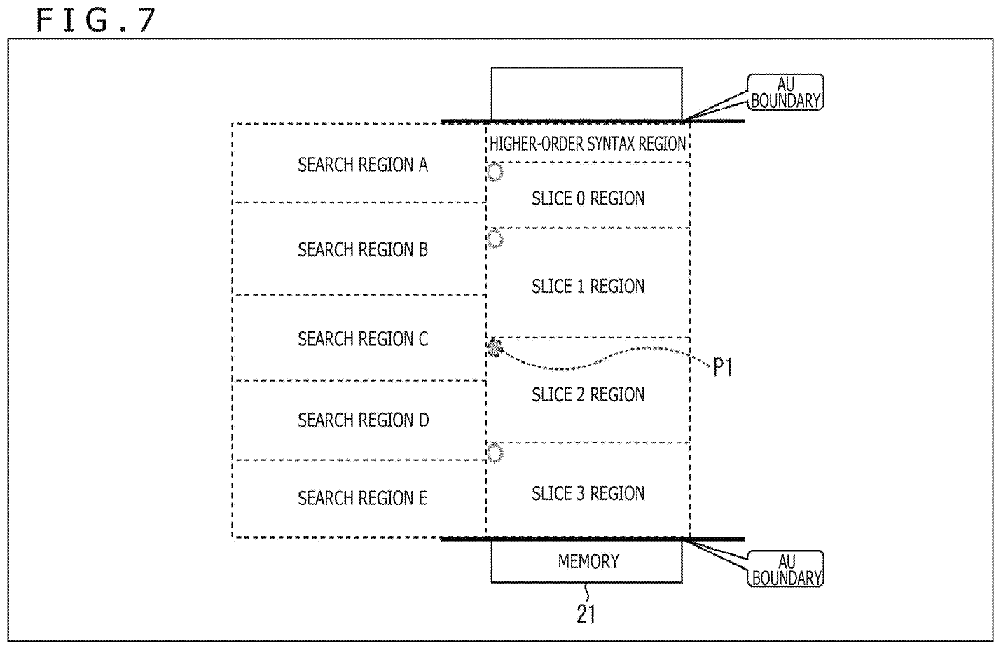

FIG. 7 is a view depicting a first example of searching for a slice start position.

FIG. 7 gives an example in which a search is made for an allocation point in reference to which four slices constituting the AU are allocated to two decoding sections 22. It is to be noted that the explanations already given with respect to FIG. 2 are omitted below where appropriate.

In the example of FIG. 7, a higher-order syntax region, a slice 0 region, a slice 1 region, a slice 2 region, and a slice 3 region are formed in the memory 21. The number of bytes in the slice 0 region and slice 1 region put together is close to the number of bytes in the slice 2 region and slice 3 region put together.

In a case where the number of divisions is five, the AU is divided into search regions A through E evenly in units of a predetermined number of bytes, as depicted in FIG. 7.

The search region A is a region ranging from the AU start position to a given position in the slice 0 region. The search region B is a region ranging from the given position in the slice 0 region to a given position in the slice 1 region. The search region C is a region ranging from the given position in the slice 1 region to a given position in the slice 2 region.

The search region D is a region ranging from the given position in the slice 2 region to a given position in the slice 3 region. The search region E is a region ranging from the given position in the slice 3 region to the end position of the AU.

In this case, the decoding apparatus 11 starts a search for a slice start position constituting the allocation point by assuming the search region C as the likely candidate region. For example, a search is started from the given position in the slice 1 region that is the start position of the search region C.

That is, the search is not performed sequentially from the AU start position included in the search region A. Instead, the search is made preferentially from the search region C where the allocation point is highly likely to exist. As will be discussed later, the search region where the allocation point is highly likely to be found is obtained on the basis of the number of slices and the number of configured decoding sections, for example.

In a case where the start position of slice 2 is detected in the search region C, the decoding apparatus 11 determines the start position of slice 2 as an allocation point P1 and terminates the search. In the example of FIG. 7, the start position of slice 2 is included in the search region C. That is, the search is not made through the search regions A and B preceding the search region C, as well as through the search regions D and E subsequent to the search region C.

In reference to the start position of slice 2, the decoding apparatus 11 allocates slice 0 and slice 1 to the decoding section 22-1 and slice 2 and slice 3 to the decoding section 22-2.

<Second Example of Searching for the Slice Start Position>

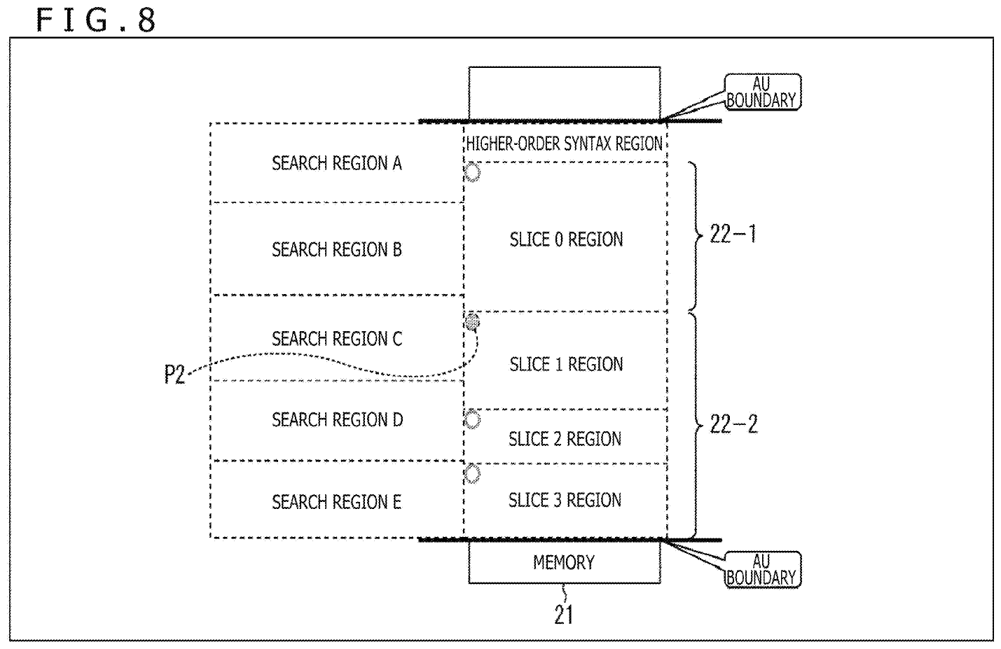

FIG. 8 is a view depicting a second example of searching for a slice start position.

FIG. 8 gives an example in which a search is made for an allocation point in a case where the number of bytes is uneven between the slices. The explanations already given with respect to FIG. 7 are omitted below where appropriate.

The number of bytes in the slice 0 region is close to the number of bytes in the slice 1 region, slice 2 region, and slice 3 region put together.

In a case where the number of divisions is five, the AU is divided into search regions A through E evenly in units of a predetermined number of bytes, as depicted in FIG. 8.

The search region A is a region ranging from the AU start position to a given position in the slice 0 region. The search region B is a region ranging from the given position in the slice 0 region to a given position in the latter half of the slice 0 region. The search region C is a region ranging from the given position in the latter half of the slice 0 region to a given position in the slice 1 region.

The search region D is a region ranging from the given position in the slice 1 region to a given position in the slice 2 region. The search region E is a region ranging from the given position in the slice 2 region to the AU end position.

In this case, the decoding apparatus 11 starts searching for a slice start position constituting the allocation point by assuming the search region C as the likely candidate region. For example, the search is started from the given position in the slice 1 region that is the start position of the search region C.

That is, also in the case of FIG. 8, the search is not performed sequentially from the AU start position included in the search region A. Instead, the search is made preferentially from the search region C where the allocation point is highly likely to exist.

In a case where the start position of slice 1 is detected in the search region C, the decoding apparatus 11 determines the start position of slice 1 as an allocation point P2 and terminates the search. In the example of FIG. 8, the start position of slice 1 is included in the search region C. That is, the search is not made through the search regions A and B preceding the search region C, as well as through the search regions D and E subsequent to the search region C.

In reference to the start position of slice 1, the decoding apparatus 11 allocates slice 0 to the decoding section 22-1 and slice 1, slice 2, and slice 3 to the decoding section 22-2.

On the other hand, in a case where an equal number of slices are allocated to the decoding sections 22-1 and 22-2 as in the ordinary case, slice 0 and slice 1 are allocated to the decoding section 22-1 and slice 2 and slice 3 are allocated to the decoding section 22-2.

Given the AU with its slices configured as depicted in FIG. 8, the number of bytes processed by each decoding section 22 is approximately the same with the present technology as in the ordinary case. In the ordinary case, however, the number of bytes to be processed may be uneven between the decoding sections depending on the slice configuration.

<Third Example of Searching for the Slice Start Position>

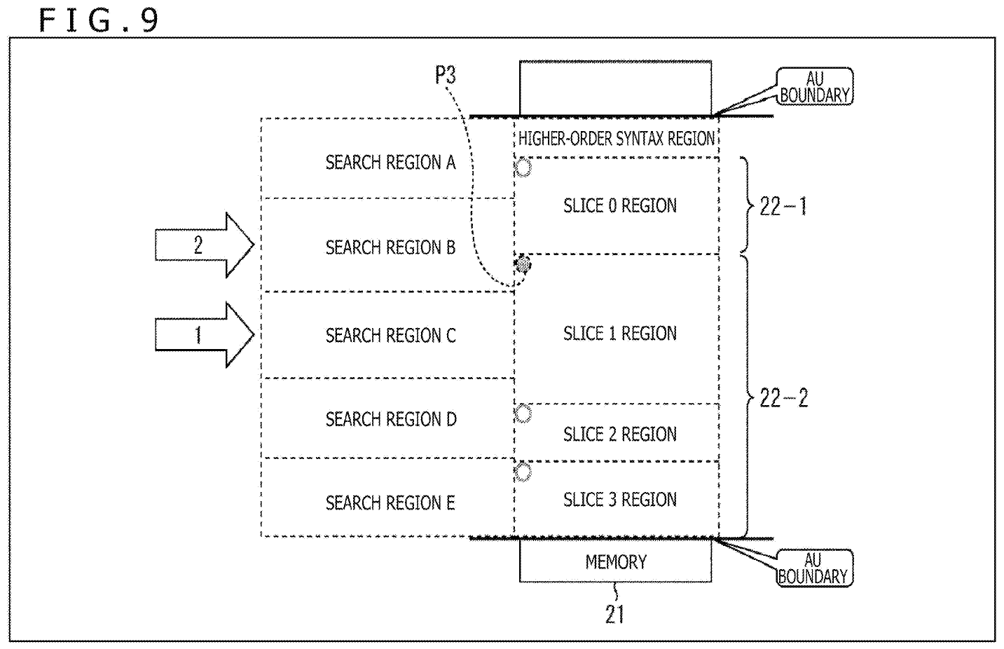

FIG. 9 is a view depicting a third example of the process of searching for a slice start position.

FIG. 9 gives an example in which an allocation point is not detected in the first search region. The explanations already given with respect to FIG. 7 are omitted below where appropriate.

As in the case of FIG. 7, the decoding apparatus 11 starts a search for a slice start position by assuming the search region C as the likely candidate region. A hollow arrow with the numeral 1 inside pointing to the search region C indicates that the search region C is searched first.

In a case where the number of divisions is five, the AU is divided into search regions A through E evenly in units of a predetermined number of bytes, as depicted in FIG. 9.

The search region A is a region ranging from the AU start position to a given position in the slice 0 region. The search region B is a region ranging from the given position in the slice 0 region to a given position in the slice 1 region. The search region C is a region ranging from the given position in the slice 1 region to a given position in the latter half of the slice 1 region.

The search region D is a region ranging from the given position in the latter half of the slice 1 region to a given position close to the end of the slice 2 region. The search region E is a region ranging from the given position close to the end of the slice 2 region to the AU end position.

In this case, the decoding apparatus 11 starts a search for a slice start position constituting the allocation point by assuming the search region C as the likely candidate region. For example, the search is started from the given position in the slice 1 region that is the start position of the search region C.

In a case where the start position of slice 1 is not detected in the search region C, the decoding apparatus 11 starts the search from the given position in slice 0 that is the start position of the search region B positioned close to the search region C. Here, the closely positioned search region signifies the search region positioned immediately above or below (close to) the search region that has been searched already.

In a case where the start position of slice 1 is detected in the search region B, the decoding apparatus 11 determines the start position of slice 1 as an allocation point P3. In the example of FIG. 9, the start position of slice 1 is included in the search region B.

In reference to the start position of slice 1, the decoding apparatus 11 allocates slice 0 to the decoding section 22-1 and slice 1, slice 2, and slice 3 to the decoding section 22-2.

If the start position of slice 1 is not detected in the search region B, the search proceeds through the search region D positioned close to (near) the search region C and through the search region A positioned close to the search region B. The search is thus performed consecutively through the search regions positioned close to the centrally positioned search region C. It follows that the method of division into regions and the order in which the divided regions are searched are important.

Even if such a search is made for each of the search regions successively and fails to detect the start position of the slice region until the last region by any chance, with all other regions having been searched, the required processing time is substantially the same as in the ordinary case. In this respect, penalty may be said to be virtually nonexistent.

<Search Algorithm>

The algorithm for implementing the above-described search is explained below.

[1. Method of division into the search regions]

The search regions are formed by evenly dividing the entire AU by a given division number. Such even division is intended to even out the processing amounts for the individual decoding sections 22.

Here, it is assumed that α₀ stands for the initial address of the AU, s for the size of the AU, and d for an n-th search region among the numbered divisions. On this assumption, an address αₙ is given by the following mathematical expression (1).

$$\begin{matrix}[ Math . 1 ] & \\ {α}_{n} = {α}_{0} + n \frac{s}{d} ( n = 0 , 1 , … , d - 1 ) & ( 1 )\end{matrix}$$

Incidentally, the division number d also assumes the role of a tuning parameter. Thus, it is not mandatory to apply the division number d to the mathematical expression (1) above. The division number d may be selected by the user depending on the system in use and on the use case. This makes it possible to devise applications that correspond to its own environment.

The larger the division number d becomes, the shorter the time for searching one search region. In this case, one search region becomes narrower and is less likely to include a slice start position. Conversely, the smaller the division number d becomes, the longer the time for searching one search region. In this case, one search region is more likely to include a slice start position.

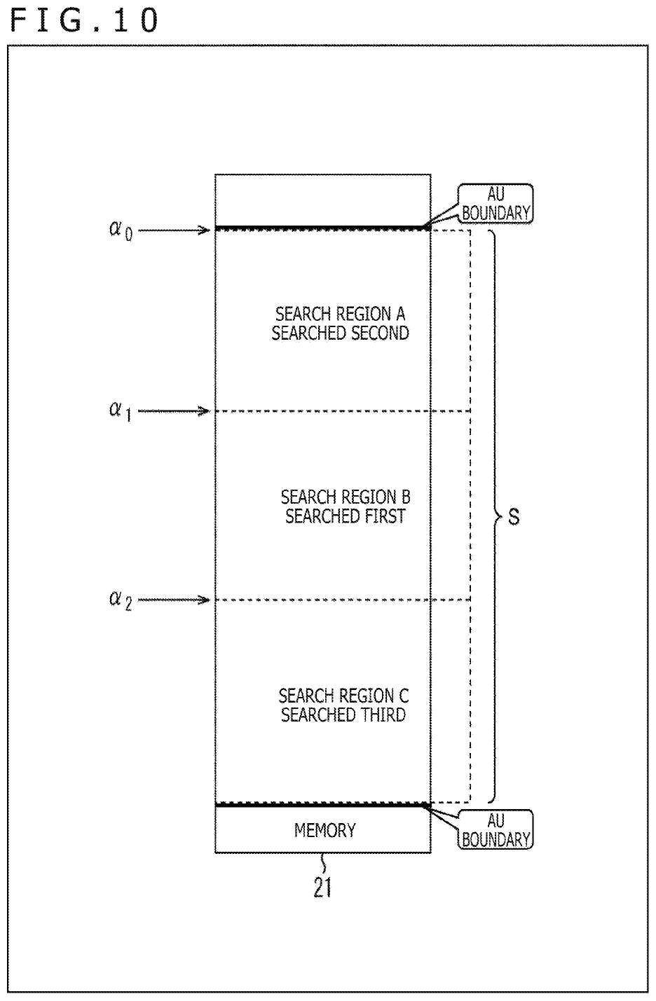

FIG. 10 is a view depicting an example in which the AU is divided into three search regions.

In FIG. 10, the search region A is a region ranging from address α₀ to address α₁, and the search region B is a region ranging from address α₁ to address α₀. The search region C is a region ranging from address α₀ to the AU boundary.

The division number d may be defined by the number of decoding sections configured and by a predicted number of regions assumed by each decoding section 22, for example. If it is assumed that h stands for the number of the decoding sections 22 and r for the predicted number of assumed regions, the division number d is given by the following mathematical expression (2).

[Math. 2]

d=rh−1 (2)

Here, the predicted number r of assumed regions is a predicted number of slices to be processed by one decoding section 22. If there are no fractions, the predicted number r of assumed regions becomes equivalent to the number of evenly allocated slices.

[2. Method of Determining the Order of Search]

The order of search is set as the descending order of possibility of a slice start position being present as the allocation point starting from within the likely candidate region. In a case where the division number d is obtained by use of the mathematical expression (2) above, a likely candidate region r_{d} is defined by the following mathematical expression (3).

[Math. 3]

r_{d}=rm(m=1, . . . ,h−1) (3)

If it is assumed that the number of bytes per slice is even in the mathematical expression (3) above, that means the likely candidate region r_{d} appears as one of the predicted number r of assumed regions. It is to be noted that the number r_{d} is an ordinal number. In a case where the likely candidate region r_{d} is initially searched and where the slice start position is not detected in that likely candidate region r_{d}, then the region immediately above or below the likely candidate region r_{d} is searched. It does not matter whether the upper or the lower region is searched first at this time.

It is to be noted that the number of slices is determined by the encoding format. Therefore, the likely candidate region may be obtained alternatively by use of the encoding format. For example, the encoding format may determine that the number of slices is to be in the range of eight or smaller. Also, although the content of each slice differs more or less from that of the preceding AU, the break positions between the slices may differ little from those in the preceding AU unless there is a switch of scene. Thus, the slice start position searched in the preceding AU may be retained, and the search region that includes the retained slice start position from the preceding AU may be used as the likely candidate region.

In the example of FIG. 10, the search region B is searched first as the likely candidate region. The search region A positioned immediately above the search region B is searched second. The search region C positioned immediately below the search region B is searched third.

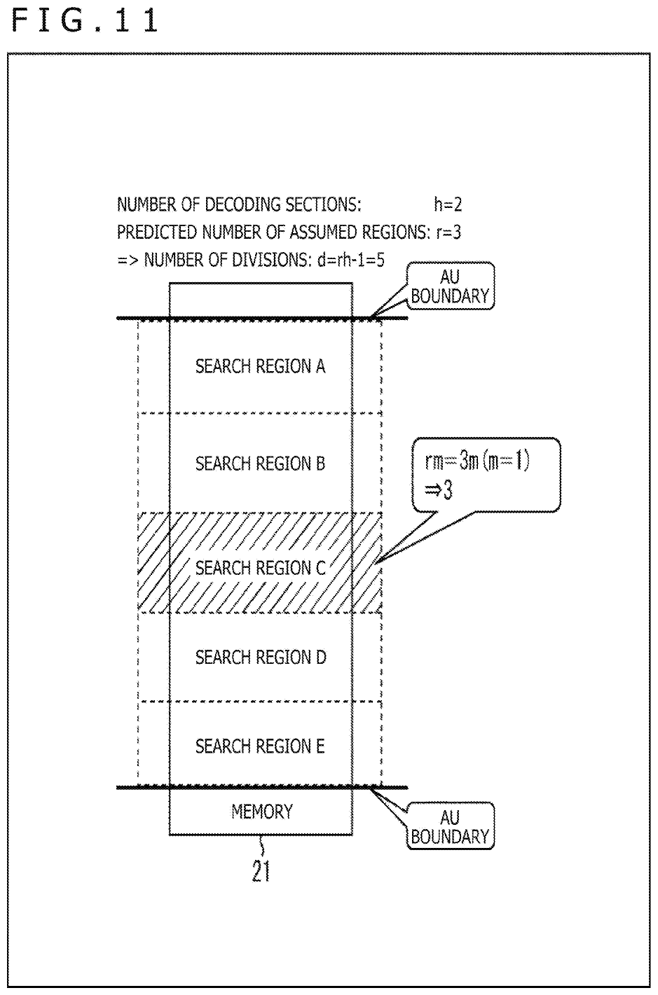

FIG. 11 is a view depicting another typical order of search.

As depicted in FIG. 11, in a case where the predicted number of assumed regions is three, the likely candidate region is determined to be the third search region C from the top. That is, the search region C is searched first. When the slice start position is detected, the search is terminated.

In a case where the slice start position is not detected in the search region C, the search region B or D is searched. When the slice start position is detected, the search is terminated.

The purpose of search is to allocate the slices to be assumed by each of the decoding sections 22 and not to detect all slices. Thus, the search is terminated at the moment when the slice start position is detected.

<Example of Search Performed by the Decoding Apparatus Having Three Decoding Sections>

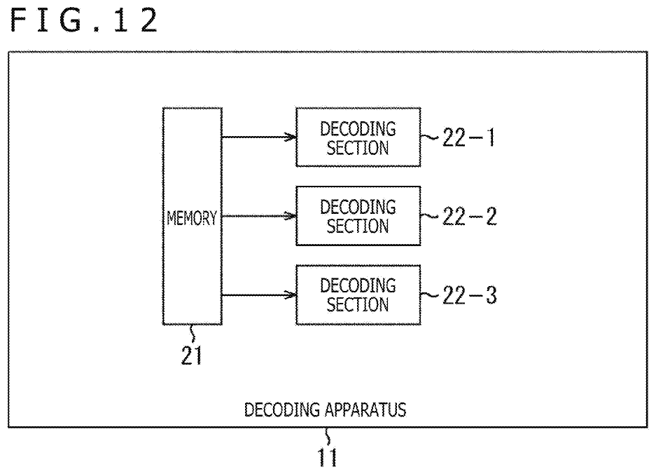

FIG. 12 is a block diagram depicting another simplified configuration example of the decoding apparatus.

The decoding apparatus 11 depicted in FIG. 12 is different from the decoding apparatus 11 in FIG. 6 in that decoding sections 22-2 and 22-3 are added. The explanations already given with respect to FIG. 6 are omitted below where appropriate.

The decoding apparatus 11 starts searching for the start positions of two slices in order to allocate the slices to the three decoding sections 22-1 to 22-3. The search for the start positions of the two slices is started in two likely candidate regions that are highly likely to include the slice start positions constituting two allocation points.

In a case where the decoding apparatus 11 detects a first allocation point and a second allocation point by searching the two likely candidate regions, the decoding apparatus 11 terminates the search at that point in time. In reference to the first and the second allocation points, the decoding apparatus 11 allocates the AU data to the decoding sections 22-1 to 22-3 individually to let them decode the allocated data.

For example, the data preceding the first allocation point is allocated to the decoding section 22-1, and the data subsequent to the first allocation point and preceding the second allocation point is allocated to the decoding section 22-2. The data subsequent to the second allocation point is allocated further to the decoding section 22-3.

<Searching for the Slice Start Positions>

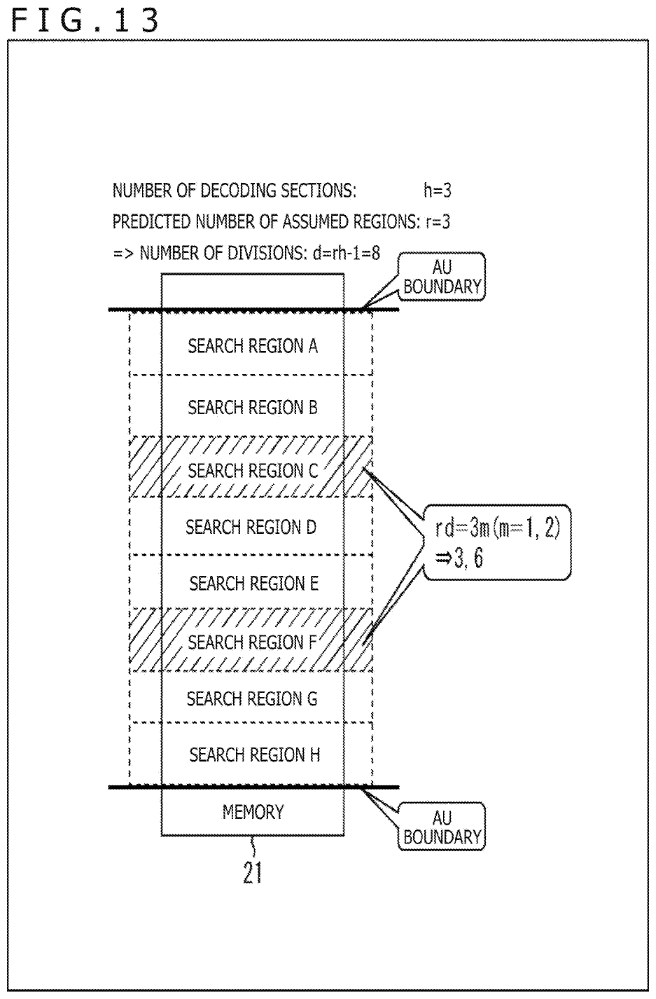

FIG. 13 is a view depicting a typical order of search performed by the decoding apparatus 11 in FIG. 12.

As depicted in FIG. 13, in a case where the division number d is eight, search regions A through H are formed. If the predicted number of assumed regions is three in this case, the likely candidate regions are determined to be the third search region C and the six search region F from the top.

Thus, the search is started in the search region C followed by the search region F. In the case where two likely candidate regions exist, as depicted in FIG. 13, the search may be started either in the upper-positioned likely candidate region or in the lower-positioned likely candidate region.

In a case where a slice start position is detected in the search region C, the detected slice start position is determined to be the first allocation point, and the search is started in the search region F. In a case where a slice start position is detected in the search region F, the detected slice start position is determined to be the second allocation point, and the search is terminated.

In a case where a slice start position is detected not in the search region C but in the search region F, the search is started in the search region B or in the search region D. When a slice start position is detected in the search region B or D, the detected slice start position is determined to be the first allocation point, and the search is terminated.

In a case where a slice start position is detected not in the search region F but in the search region C, the search is started in the search region E or in the search region G. When a slice start position is detected in the search region E or G, the detected slice start position is determined to be the second allocation point, and the search is terminated.

In a case where a slice start position is not detected in the search region C or in the search region F, the search is started in the search region B or in the search region D. When a slice start position is detected in the search region B or D, the detected slice start position is determined to be the first allocation point, and the search is started in the search region E or in the search region G. When a slice start position is detected in the search region E or G, the detected slice start position is determined to be the second allocation point, and the search is terminated.

In a case where a slice start position is not detected in the search region B or in the search region D, the search is started in the search region A. When a slice start position is detected in the search region A, the detected slice start position is determined to be the first allocation point, and the search is terminated.

In a case where a slice start position is not detected in the search region E or in the search region G, the search is started in the search region H. When a slice start position is detected in the search region H, the detected slice start position is determined to be the second allocation point, and the search is terminated.

Alternatively, the search may be performed in the search regions C, B, D, A and E, in that order. As another alternative, the search may be performed in the search regions C, D, B, E and A, in that order. As a further alternative, the search may be made in the search regions C, B, A, D and E, in that order.

<Alternative Examples>

In the mathematical expression (1) above, the term α₀ stands for the initial address of the target. Alternatively, α₀ may represent an address subsequent to the higher-order syntax. In this case, the term s in the expression (1) may denote the size of the higher-order syntax instead of the size of the AU. This puts more emphasis on the slices.

In the mathematical expression (2) above, the division number is calculated by use of the number of decoding sections and the predicted number of assumed regions. However, this is not limitative of the method of calculation. Alternatively, the division number may be determined as desired.

<Example of Search Performed by the Decoding Apparatus Having Four Decoding Sections>

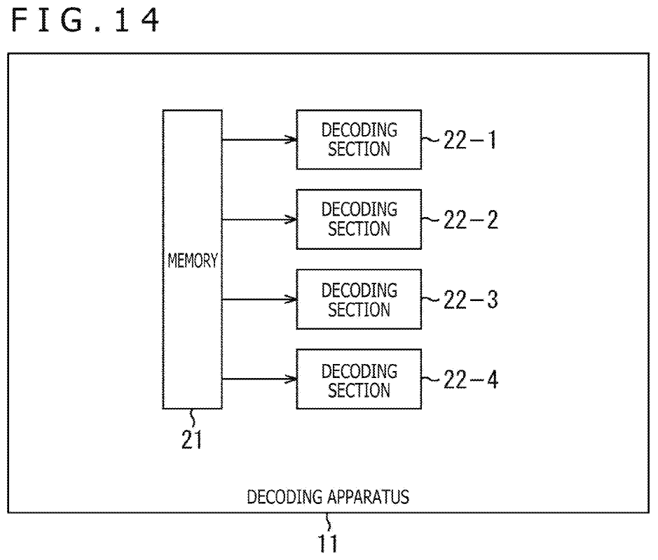

FIG. 14 is a block diagram depicting another simplified configuration example of the decoding apparatus.

The decoding apparatus 11 in the example of FIG. 14 is different from the decoding apparatus 11 in FIG. 6 in that decoding sections 22-2 to 22-4 are added. The explanations already given with respect to FIG. 6 are omitted below where appropriate.

In order to allocate slices to the four decoding sections 22-1 to 22-4, the decoding apparatus 11 starts searching for three slice start positions by selecting, from among the multiple search regions, three likely candidate regions that are highly likely to include the slice start positions constituting three allocation points.

In a case where the decoding apparatus 11 detects a first, a second, and a third allocation point by searching the three likely candidate regions, the decoding apparatus 11 terminates the search at that point in time. In reference to the first, the second, and the third allocation points, the decoding apparatus 11 allocates the AU data to the decoding sections 22-1 through 22-4 individually to let them decode the allocated data.

For example, the data preceding the first allocation point is allocated to the decoding section 22-1, and the data subsequent to the first allocation point and preceding the second allocation point is allocated to the decoding section 22-2. The data subsequent to the second allocation point and preceding the third allocation point is allocated to the decoding section 22-3, and the data subsequent to the third allocation point is allocated to the decoding section 22-4.

<Search for the Slice Start Positions>

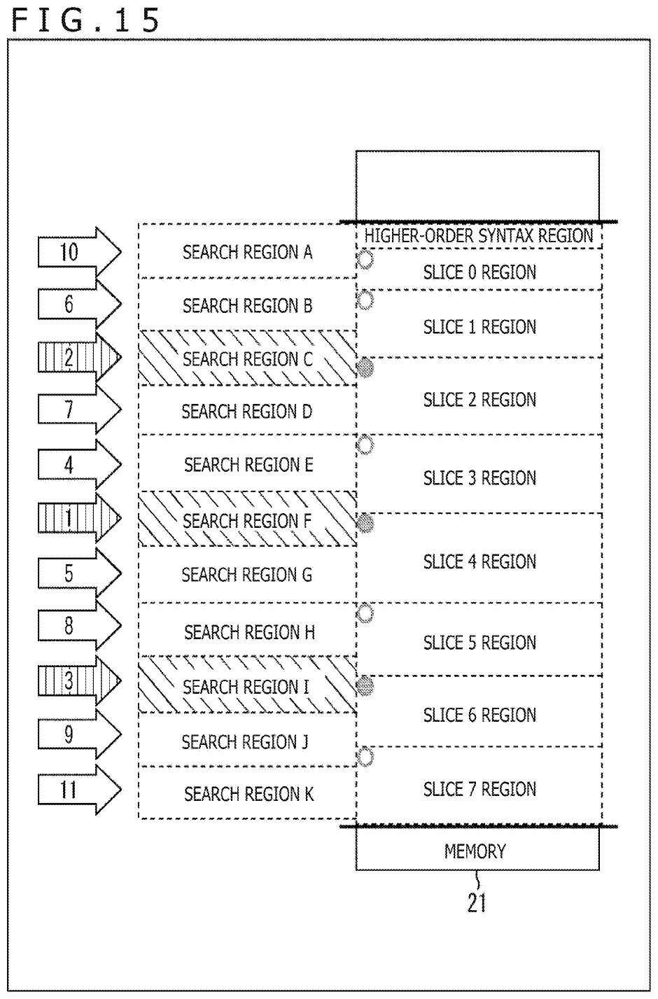

FIG. 15 is a view depicting a typical order of search performed by the decoding apparatus 11 in FIG. 14.

In the case where there are four decoding sections 22, search regions A through K are formed by dividing the AU evenly in units of a predetermined number of bytes.

The search region A is a region ranging from the AU start position to a given position in a slice 0 region. The search region B is a region ranging from the given position in the slice 0 region to a given position in a slice 1 region. The search region C is a region ranging from the given position in the slice 1 region to a given position in a slice 2 region.

The search region D is a region ranging from the given position in the slice 2 region to the end position of the slice 2 region. The search region E is a region ranging from the start position of a slice 3 region to a given position in the slice 3 region. The search region F is a region ranging from the given position in the slice 3 region to a given position in a slice 4 region.

The search region G is a region ranging from the given position in the slice 4 region to the end position of the slice 4 region. The search region H is a region ranging from the start position of a slice 5 region to a given position in the slice 5 region. The search region I is a region ranging from the given position in the slice 5 region to a given position in a slice 6 region.

The search region J is a region ranging from the given position in the slice 6 region to a given position in a slice 7 region. The search region K is a region ranging from the given position in the slice 7 region to the end position of the AU.

In FIG. 15, the numbers inside the arrows on the left side indicate the order of search. A search is made for a first, a second, and a third allocation point in the ascending order of the numbers. That is, the search is made for a slice start position in each of the search regions F, C, I, E, G, B, D, H, J, A and K, in that order. In a case where there are three likely candidate regions, as depicted in FIG. 15, the search is started in the centrally positioned likely candidate region. Thereafter, the search may be started either in the upper-positioned likely candidate region or in the lower-positioned likely candidate region.

In this case, the decoding apparatus 11 starts searching for a slice start position constituting the first allocation point by assuming the search region F as a likely candidate region. For example, the search is started from the given position in slice 3 that is the start position of the search region F.

In a case where the start position of slice 4 is detected in the search region F, the decoding apparatus 11 starts searching for a slice start position constituting the second allocation point by assuming the search region C as a likely candidate region. For example, the search is started from the given position in slice 1 that is the start position of the search region C.

In a case where the start position of slice 2 is detected in the search region C, the decoding apparatus 11 starts searching for a slice start position constituting the third allocation point by assuming the search region I as a likely candidate region. For example, the search is started from the given position in slice 5 that is the start position of the search region I.

In a case where the start position of slice 6 is detected in the search region I, the decoding apparatus 11 determines the detected start position of slice 6 as the third allocation point.

In reference to the start position of slice 2, the decoding apparatus 11 allocates slice 0 and slice 1 to the decoding section 22-1. In reference to the start position of slice 2 and that of slice 4, the decoding apparatus 11 allocates slice 2 and slice 3 to the decoding section 22-2. In reference to the start position of slice 4 and that of slice 6, the decoding apparatus 11 allocates slice 4 and slice 5 to the decoding section 22-3. In reference to the start position of slice 6, the decoding apparatus 11 allocates slice 6 and slice 7 to the decoding section 22-4.

In the manner described above, the start positions of the slices are detected by searching only the search regions F, C, and I in the fastest case.

In a case where a slice start position is not detected in the search region F, the search is started in the search region E or in the search region G. In a case where a slice start position is not detected in the search region C, the search is started in the search region B or in the search region D. In a case where a slice start position is not detected in the search region I, the search is started in the search region H or in the search region J. In a case where a slice start position is not detected in the search region B or in the search D, the search is started in the search region A. In a case where a slice start position is not detected in the search region H or in the search region J, the search is started in the search region K.

<2. Details of the Decoding Apparatus><Configuration Example of the Decoding Apparatus According to the Present Technology>

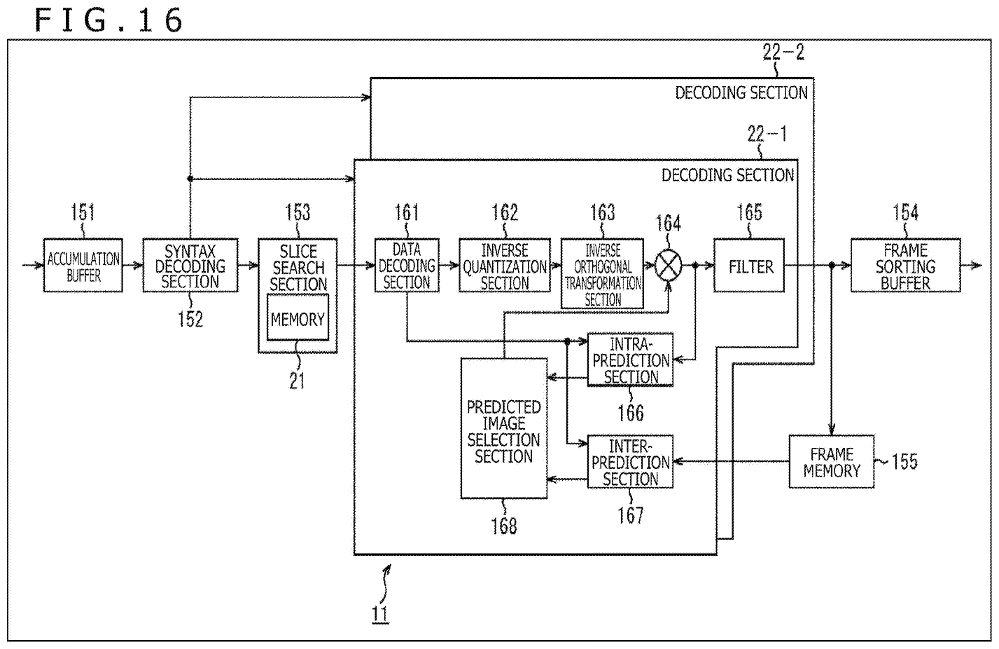

FIG. 16 is a block diagram depicting a detailed configuration example of the decoding apparatus.

In FIG. 16, the decoding apparatus 11 is configured with decoding sections 22-1 and 22-2, an accumulation buffer 151, a syntax decoding section 152, a slice search section 153 including a memory 21, a frame sorting buffer 154, and a frame memory 155.

The accumulation buffer 151 receives and accumulates a stream transmitted from the encoding apparatus 10. The accumulation buffer 151 supplies the accumulated stream to the syntax decoding section 152.

The syntax decoding section 152 decodes higher-order syntax such as AUD, VPS, SPS, PPS, and SEI. The syntax decoding section 152 outputs the decoded higher-order syntax information to the decoding sections 22. The syntax decoding section 152 outputs the stream to the slice search section 153.

The slice search section 153 has the memory 21. The slice search section 153 accumulates, into the memory 21, the stream supplied from the syntax decoding section 152, and divides the AU accumulated in the memory 21 into multiple (n) search regions in units of a predetermined number of bytes. The slice search section 153 starts searching for a slice start position by selecting, from the multiple search regions, a search range formed by a likely candidate region that is highly likely to include the slice start position constituting an allocation point.

In reference to the searched slice start position, the slice search section 153 allocates multiple slices to the decoding sections 22-1 and 22-2.

The decoding sections 22-1 and 22-2 perform the process of decoding the allocated slices. The decoding section 22-1 is configured with a data decoding section 161, an inverse quantization section 162, an inverse orthogonal transformation section 163, an addition section 164, a filter 165, an intra-prediction section 166, an inter-prediction section 167, and a predicted image selection section 168. The decoding section 22-2 is also configured in like manner.

The data decoding section 161 performs lossless decoding such as variable-length decoding or arithmetic decoding on the slice data supplied from the slice search section 153, thereby obtaining quantization values and encoding information. The data decoding section 161 supplies the quantization values to the inverse quantization section 162.

Also, the data decoding section 161 supplies the intra-prediction section 166 with intra-prediction mode information as the encoding information. The data decoding section 161 supplies the inter-prediction section 167 with a motion vector, inter-prediction mode information, and information for identifying a reference image.

Further, the data decoding section 161 supplies the predicted image selection section 168 with the intra-prediction mode information or the inter-prediction mode information as the encoding information. The data decoding section 161 supplies the filter 165 with offset filter information as the encoding information.

The inverse quantization section 162 inversely quantizes the quantization values from the data decoding section 161 in units of TUs. The inverse quantization section 162 supplies the inverse orthogonal transformation section 163 with an orthogonal transformation process result obtained from the inverse quantization.

The inverse orthogonal transformation section 163 performs the process of inverse orthogonal transformation on the orthogonal transformation process result supplied from the inverse quantization section 162. The inverse orthogonal transformation section 163 supplies the addition section 164 with residual information obtained as a result of the inverse orthogonal transformation process.

The addition section 164 adds up the residual information supplied from the inverse orthogonal transformation section 163 and a predicted image fed from the predicted image selection section 168. The addition section 164 supplies the added image to the filter 165 and to the intra-prediction section 166.

The filter 165 performs an adaptive deblocking filter process on the image supplied from the addition section 164. The filter 165 performs an adaptive offset filter process on the image resulting from the adaptive deblocking filter process using an offset indicated by the offset filter information from the data decoding section 161, the adaptive offset filter process being of the type defined by the offset filter information. The filter 165 supplies the image having undergone the adaptive offset filter process to the frame memory 155 and to the frame sorting buffer 154.

Using a peripheral image read from the addition section 164, the intra-prediction section 166 performs an intra-prediction process in an optimal intra-prediction mode indicated by the intra-prediction mode information supplied from the data decoding section 161. The intra-prediction section 166 supplies the predicted image generated as a result of the intra-prediction process to the predicted image selection section 168.

From the frame memory 155, the inter-prediction section 167 retrieves the reference image identified by the information that specifies the reference image supplied from the data decoding section 161. Using the motion vector and the reference image supplied from the data decoding section 161, the inter-prediction section 167 performs a motion compensation process in an optimal inter-prediction mode indicated by the inter-prediction mode information supplied from the data decoding section 161. The inter-prediction section 167 supplies the predicted image generated as a result of the inter-prediction process to the predicted image selection section 168.

In a case where the intra-prediction mode information is given from the data decoding section 161, the predicted image selection section 168 supplies the addition section 164 with the predicted image supplied from the intra-prediction section 166. On the other hand, in a case where the inter-prediction mode information is given from the data decoding section 161, the predicted image selection section 168 supplies the addition section 164 with the predicted image supplied from the inter-prediction section 167.

The frame sorting buffer 154 stores the image supplied from the filter 165 in units of frames. The frame sorting buffer 154 sorts the image into the original order of display.

The frame memory 155 stores the image supplied from the filter 165.

<Operation of the Decoding Apparatus>

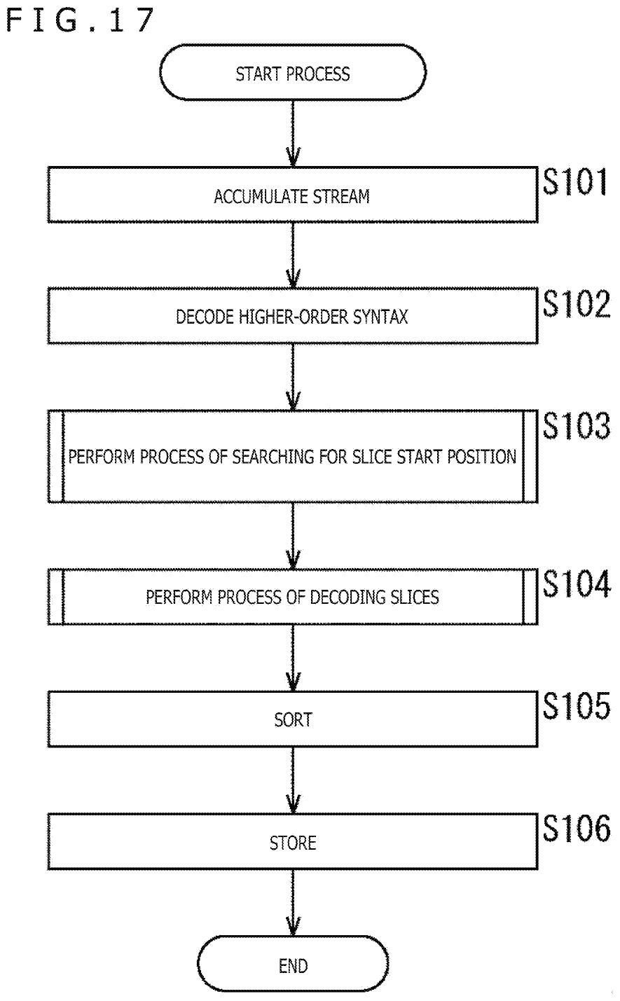

FIG. 17 is a flowchart explaining the process performed by the decoding apparatus in FIG. 16.

In step S101, the accumulation buffer 151 receives and accumulates the stream transmitted from the encoding apparatus 10. The accumulation buffer 151 supplies the stream to the syntax decoding section 152.

In step S102, the syntax decoding section 152 decodes the higher-order syntax. The syntax decoding section 152 outputs the decoded higher-order syntax information to the decoding sections 22. The syntax decoding section 152 outputs the stream to the slice search section 153.

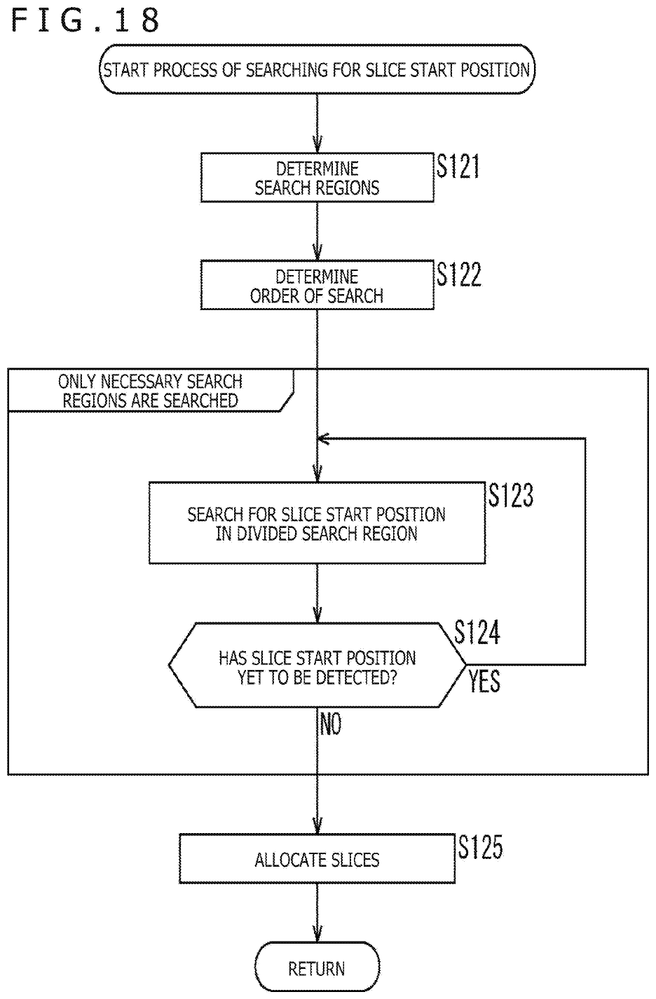

In step S103, the slice search section 153 accumulates, into the memory 21, the stream supplied from the syntax decoding section 152, and performs the process of searching for a slice start position. The process of searching for a slice start position will be discussed later in detail with reference to FIG. 18. The processing in step S103 causes the slices to be allocated to the decoding sections 22-1 and 22-2.

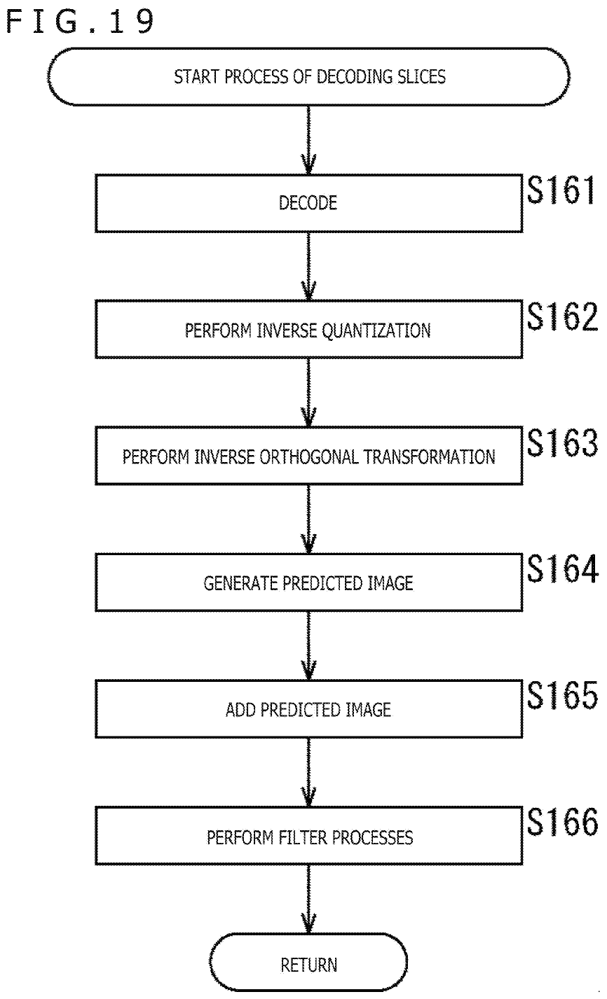

In step S104, the decoding sections 22-1 and 22-2 perform the process of decoding the allocated slices. The process of decoding slices will be discussed later in detail with reference to FIG. 19. The processing in step S104 causes each of the slices to be decoded.

In step S105, the frame sorting buffer 154 sorts the image into the original order of display.

In step S106, the frame memory 155 stores the image supplied from the filter 165.

FIG. 18 is a flowchart explaining the process of searching for a slice start position in step S103 in FIG. 17.

In step S121, the slice search section 153 determines search regions in the AU.

In step S122, the slice search section 153 determines the order of search in the search regions. At this time, a likely candidate region is also acquired.

In step S123, the slice search section 153 searches for a slice start position in a divided search region. The search is started in the acquired likely candidate region.

In step S124, the slice search section 153 determines whether or not a slice start position has yet to be detected.

In a case where it is determined in step S124 that a slice start position has yet to be detected, control is returned to step S123. The subsequent steps are then repeated.

In a case where it is determined in step S124 that the slice start position is detected, control is transferred to step S125.

In step S125, the slice search section 153 allocates the slices to each of the decoding sections 22 in reference to the detected slice start position.

In FIG. 18, the processing in steps S123 and S124 is terminated at the moment when the slice start position is detected. Thus, only the necessary search regions are searched.

FIG. 19 is a flowchart explaining the process of decoding slices in step S104 in FIG. 17.

In step S161, the data decoding section 161 decodes encoded data from the accumulation buffer 151 to obtain quantization values and encoding information. The data decoding section 161 supplies the quantization values to the inverse quantization section 162.

Also, the data decoding section 161 supplies the intra-prediction section 166 with the intra-prediction mode information as the encoding information. The data decoding section 161 supplies the inter-prediction section 167 with a motion vector, inter-prediction mode information, and information for identifying a reference image.

Further, the data decoding section 161 supplies the predicted image selection section 168 with the intra-prediction mode information or the inter-prediction mode information as the encoding information. The data decoding section 161 supplies the filter 165 with offset filter information as the encoding information.

In step S162, the inverse quantization section 162 inversely quantizes the quantization values supplied from the data decoding section 161. The inverse quantization section 162 supplies the inverse orthogonal transformation section 163 with an orthogonal transformation process result obtained from the inverse quantization.

In step S163, the inverse orthogonal transformation section 163 performs the process of inverse orthogonal transformation on the orthogonal transformation process result from the inverse quantization section 162.

In step S164, the intra-prediction section 166 or the inter-prediction section 167 generates a predicted image. That is, in a case where the inter-prediction mode information is determined to be supplied from the data decoding section 161, the inter-prediction section 167 retrieves the reference image based on reference image identification information supplied from the data decoding section 161.

Using the motion vector and the reference image, the inter-prediction section 167 performs a motion compensation process in an optimal inter-prediction mode indicated by the inter-prediction mode information so as to generate a predicted image. The inter-prediction section 167 supplies the resulting predicted image to the addition section 164 via the predicted image selection section 168.

On the other hand, in a case where the intra-prediction mode information is supplied to the intra-prediction section 166, the intra-prediction section 166 performs an intra-prediction process in an intra-prediction mode indicated by the intra-prediction mode information using a peripheral image from the addition section 164. The intra-prediction section 166 supplies the predicted image resulting from the intra-prediction process to the addition section 164 via the predicted image selection section 168.

In step S165, the addition section 164 adds up the residual information supplied from the inverse orthogonal transformation section 163 and the predicted image fed from the predicted image selection section 168. The addition section 164 supplies the added image to the filter 165 and to the intra-prediction section 166.

In step S166, the filter 165 performs a deblocking filter process on the image supplied from the addition section 164.

Given the image thus processed, the filter 165 performs an adaptive offset filter process on each LCU on the basis of the offset filter information from the data decoding section 161. The filter 165 supplies the image having undergone the adaptive offset filter process to the frame memory 155 and to the frame sorting buffer 154.

According to the present technology, by contrast, the access unit including multiple process regions is divided into multiple search regions with sizes different from those of the process regions. The search for the start position of the process region serving as the reference for allocating the process regions to each of multiple decoding sections is started in the likely candidate region constituted by the search region highly likely to include the start position.

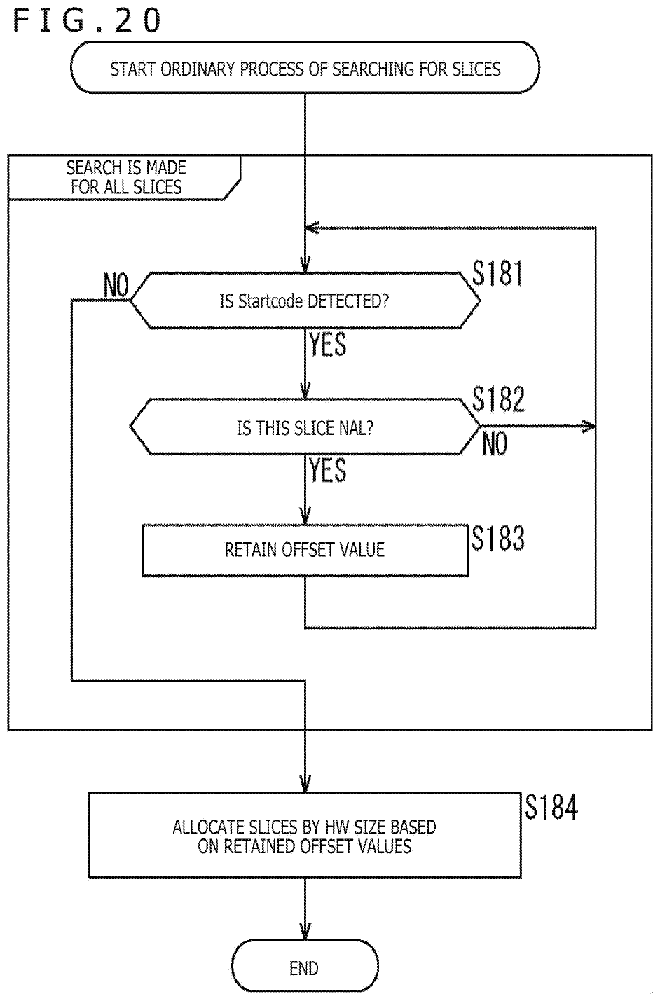

FIG. 20 is a flowchart explaining an ordinary process of searching for slices.

In step S181, it is determined whether or not a StartCode is detected. In a case where a StartCode is determined to be detected in step S181, control is transferred to step S182.

In step S182, it is determined whether or not a NAL UNIT starting from the detected StartCode is a slice NAL. In a case where the NAL UNIT is determined to be a slice NAL in step S182, control is transferred to step S183.

In step S183, the offset value of the detected StartCode is retained.

In a case where it is determined in step S182 that the NAL UNIT is determined not to be a slice NAL, control is returned to step S181.

In a case where it is determined in step S181 that a StartCode is not detected, control is transferred to step S184.

In step S184, the multiple slices are allocated to the decoding sections in units of HW sizes.

In FIG. 20, the processing in steps S181 to S183 involves searching for all slices. That is, ordinarily, the processing in step S184 is reached only after the search has been made for all slices.

Ordinarily, the entire AU is searched as described above. By contrast, the present technology allows the number of search regions to be limited. Thus, a significant reduction in processing time is expected.

In a case where a division point is detected in an n-th search region given the division number d, the search is ordinarily performed throughout the entire AU, i.e., at a full rate of d/d (=100)%. By contrast, the present technology allows the search to end at the moment when an allocation point is detected. This translates into the search being carried out at a reduced rate of n/d %.

For example, in a case where the number of decoding sections is two, where the predicted number of assumed regions is six, and where a division point is detected in the first search region, the division number d is 11. The time of searching for a slice position is then reduced approximately to 1/11 (=9)%.

According to the present technology, even a worst-case search merely amounts to the ordinary total search throughout the entire AU.

The present technology applies not only to slices but also to tiles as the process regions.

<3. Computer>

<Hardware Configuration Example of the Computer>

The series of processes described above may be executed either by hardware or by software. In a case where the series of processing is to be carried out by software, the programs constituting the software are installed into a computer. Variations of the computer include one with the software installed beforehand in its dedicated hardware, and a general-purpose personal computer or like equipment capable of executing diverse functions based on the programs installed therein.

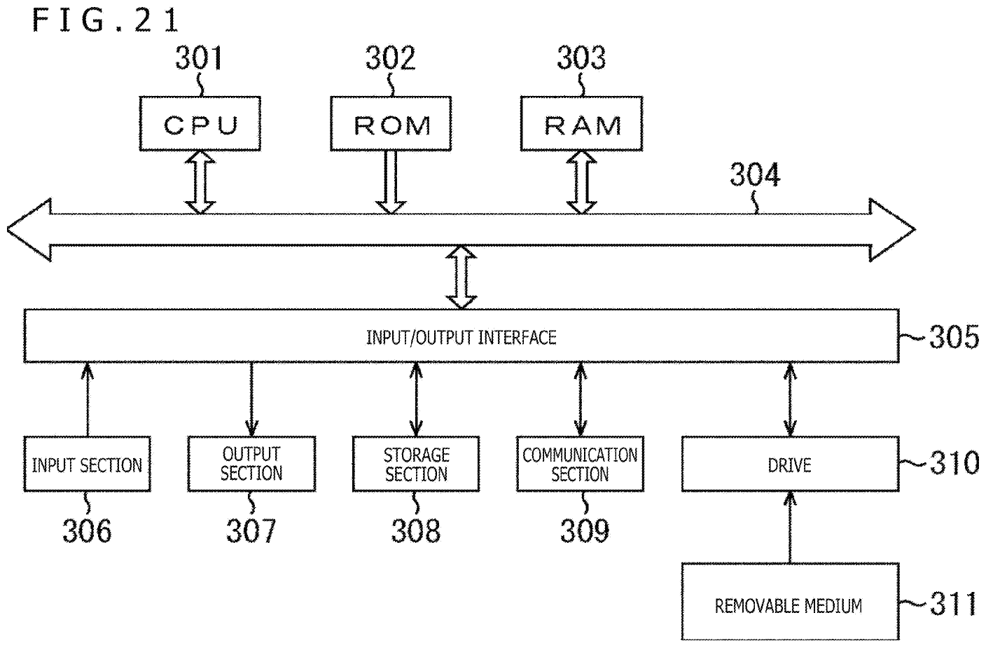

FIG. 21 is a block diagram depicting a hardware configuration example of a computer that performs the above-described series of processes using programs.

In the computer, a CPU (Central Processing UNIT) 301, a ROM (Read Only Memory) 302, and a RAM (Random Access Memory) 303 are interconnected via a bus 304.

The bus 304 is further connected with an input/output interface 305. The input/output interface 305 is connected with an input section 306, an output section 307, a storage section 308, a communication section 309, and a drive 310.

The input section 306 is configured with a keyboard, a mouse, and a microphone. The output section 307 is configured with a display device and speakers. The storage section 308 is configured with a hard disk and a nonvolatile memory. The communication section 309 is configured with a network interface. The drive 310 drives removable medium 311 such as a magnetic disk, an optical disk, a magneto-optical disk, or a semiconductor memory.

In the computer configured as described above, the CPU 301 performs the above-mentioned series of processing by loading appropriate programs from the storage section 308 into the RAM 303 via the input/output interface 305 and the bus 304 and by executing the loaded programs.

The programs to be executed by the computer (CPU 301) may be recorded, for example, on the removable medium 311 as a packaged medium when offered. The programs may also be offered via wired or wireless transmission media such as local area networks, the Internet, or digital satellite broadcasting.

In the computer, the programs may be installed into the storage section 308 via the input/output interface 305 from the removable medium 311 attached to the drive 310. The programs may also be installed into the storage section 308 after being received by the communication section 309 via wired or wireless transmission media. The programs may alternatively be preinstalled in the ROM 302 or in the storage section 308.

In this description, it is noted that the programs for execution by the computer may be carried out chronologically in the depicted sequence, in parallel, or on an as-needed basis such as when they are invoked.

In this description, the term “system” refers to an aggregate of multiple components (e.g., apparatuses or modules (parts)). It does not matter whether or not all components are housed in the same enclosure. Thus, a system may be configured with multiple apparatuses housed in separate enclosures and interconnected via a network, or with a single apparatus in a single enclosure that houses multiple modules.

The advantageous effects stated in this description are only examples and not limitative of the present technology that may also provide other advantages.

The present technology is not limited to the embodiments discussed above and may be implemented in diverse variations so far as they are within the scope of the present technology.

For example, the present technology may be implemented as a cloud computing setup in which a single function is processed cooperatively by multiple networked apparatuses on a shared basis.

Also, each of the steps discussed in reference to the above-described flowcharts may be executed either by a single apparatus or by multiple apparatuses on a shared basis.

Furthermore, in a case where a single step includes multiple processes, these processes may be executed either by a single apparatus or by multiple apparatuses on a shared basis.

<Typical Combinations of the Configured Components>

The present technology can also take the following configurations.
(1)

An image processing apparatus including:

a search section configured to divide an access unit constituted by multiple process regions into multiple search regions having sizes different from those of the process regions, the search section being further configured to perform a search for a start position of the process region serving as a reference by which to allocate the process regions to multiple decoding sections individually, the search section being further configured to start the search in a likely candidate region formed by the search region highly likely to include the start position.
(2)

The image processing apparatus as stated in paragraph (1) above, in which

in a case where the process region start position is not detected in the search region highly likely to include the start position, the search section searches for the process region start position in the search region positioned close to the likely candidate region.
(3)

The image processing apparatus as stated in paragraph (2) above, in which

in a case where the process region start position is not detected in a first search region positioned close to the likely candidate region, the search section searches for the process region start position in a second search region positioned close to the likely candidate region, and

in a case where the process region start position is not detected in the second search region positioned close to the likely candidate region, the search section searches for the process region start position in a search region positioned close to the first search region.
(4)

The image processing apparatus as stated in paragraph (1) or (2) above, in which

the search section determines the likely candidate region on the basis of the number of the decoding sections.
(5)

The image processing apparatus as stated in paragraph (1) or (2) above, in which

the search section determines the likely candidate region on the basis of an encoding format.
(6)

The image processing apparatus as stated in paragraph (1) or (2) above, in which

the search section determines the likely candidate region on the basis of the process region start position in the immediately preceding access unit searched.
(7)

The image processing apparatus as stated in any one of paragraphs (1) to (6) above, in which

the search section divides the access unit into the search regions each having an equal size.
(8)

The image processing apparatus as stated in any one of paragraphs (1) to (7) above, in which

the process regions include slices.
(9)

The image processing apparatus as stated in any one of paragraphs (1) to (8) above, further including:

the multiple decoding sections configured to decode the process regions allocated in reference to the process region start position.
(10)

The image processing apparatus as stated in any one of paragraphs (1) to (9) above, in which

in a case where there are two decoding sections, the search section searches for the process region start position in the single likely candidate region.
(11)

The image processing apparatus as stated in any one of paragraphs (1) to (9) above, in which

in a case where there are three decoding sections, the search section searches for the process region start position in the two likely candidate regions.
(12)

An image processing method including:

causing an image processing apparatus to divide an access unit constituted by multiple process regions into multiple search regions having sizes different from those of the process regions, the image processing apparatus being further caused to perform a search for a start position of the process region serving as a reference by which to allocate the process regions to multiple decoding sections individually, the image processing apparatus being further caused to start the search in a likely candidate region formed by the search region highly likely to include the process region start position.

### REFERENCE SIGNS LIST

1 Image processing system, 10 Encoding apparatus, 11 Decoding apparatus, 21 Memory, 22, 22-1 to 22-4 Decoding sections, 151 Accumulation buffer, 152 Syntax decoding section, 153 Slice search section, 154 Frame sorting buffer, 155 Frame memory

1. An image processing apparatus comprising:
a search section configured to divide an access unit constituted by multiple process regions into multiple search regions having sizes different from those of the process regions, the search section being further configured to perform a search for a start position of the process region serving as a reference by which to allocate the process regions to multiple decoding sections individually, the search section being further configured to start the search in a likely candidate region formed by the search region highly likely to include the process region start position.

2. The image processing apparatus according to claim 1, wherein
in a case where the process region start position is not detected in the search region highly likely to include the start position, the search section searches for the process region start position in the search region positioned close to the likely candidate region.

3. The image processing apparatus according to claim 2, wherein
in a case where the process region start position is not detected in a first search region positioned close to the likely candidate region, the search section searches for the process region start position in a second search region positioned close to the likely candidate region, and
in a case where the process region start position is not detected in the second search region positioned close to the likely candidate region, the search section searches for the process region start position in a search region positioned close to the first search region.

4. The image processing apparatus according to claim 1, wherein
the search section determines the likely candidate region on a basis of the number of the decoding sections.

5. The image processing apparatus according to claim 1, wherein
the search section determines the likely candidate region on a basis of an encoding format.

6. The image processing apparatus according to claim 1, wherein
the search section determines the likely candidate region on a basis of the process region start position in the immediately preceding access unit searched.

7. The image processing apparatus according to claim 1, wherein
the search section divides the access unit into the search regions each having an equal size.

8. The image processing apparatus according to claim 1, wherein
the process regions include slices.

9. The image processing apparatus according to claim 1, further comprising:
the multiple decoding sections configured to decode the process regions allocated in reference to the process region start position.

10. The image processing apparatus according to claim 1, wherein
in a case where there are two decoding sections, the search section searches for the process region start position in the single likely candidate region.

11. The image processing apparatus according to claim 1, wherein
in a case where there are three decoding sections, the search section searches for the process region start position in the two likely candidate regions.

12. An image processing method comprising:
causing an image processing apparatus to divide an access unit constituted by multiple process regions into multiple search regions having sizes different from those of the process regions, the image processing apparatus being further caused to perform a search for a start position of the process region serving as a reference by which to allocate the process regions to multiple decoding sections individually, the image processing apparatus being further caused to start the search in a likely candidate region formed by the search region highly likely to include the process region start position.
